(19) United States
(12) Patent Application Publication
(10) Pub. No.: US 2015/0107115 A1
(43) Pub. Date: Apr. 23, 2015

(54) Disposable Razor Device and Blades (Two Blades on a Movable Head and a Single Blade on a Head Fixed to the Razor Device) for Use at Barbershops, Hairdressing Salons and Homes

(71) Applicant: Mansour Alsaify Mubarak Al Ajmy, Al Fintas (KW)

(72) Inventor: Mansour Alsaify Mubarak Al Ajmy, Al Fintas (KW)

(21) Appl. No.: 14/056,304

(22) Filed: Oct. 17, 2013

(51) Int. Cl. B26B 21/06; B26B 21/40

(52) U.S. Cl. CPC B26B 21/06; B26B 21/4068
USPC 30/50; 264/219

(57) ABSTRACT

A disposable razor device includes a handle with a distal end, a proximal end, and a body extending therebetween, a fixed head integral with the handle, at least one fixed razor blade attached to a bottom edge of the fixed head, and a removable head with a protection strip and at least one razor blade inserted therein. The removable head is configured to be attached to and removed from the fixed head of the razor device. A push button release mechanism may be positioned on the handle, wherein the actuation of the push button allows the removable head to be detached from the fixed head. The removable head may include two razor blades. The protection strip is positioned above the two razor blades in the removable head. The two razor blades of the removable head may be positioned above the fixed razor blade of the fixed head.

### BACKGROUND OF THE INVENTION

1. Field of the Invention

This disclosure relates generally to a razor device and blades and, more particularly, to a disposable razor device with a movable head and an integral razor blade fixed to the razor device.

2. Description of Related Art

It is known that the disposable razor blades currently available in the markets are very painful to the user while trying to remove long hair by using them, which leads to a difficulty in shaving at homes or even at salons. Moreover, there are many of the recently used razor devices of the type in which the blades are replaced while retaining the device itself, thereby increasing the chances of contamination of the device and contributing in transmission of the infection of various diseases such as allergic skin diseases in addition to more serious diseases such as hepatitis and AIDS (blood-transmitted diseases).

### SUMMARY OF THE DISCLOSURE

The invention aims to provide a comprehensive usage including long and short hair shaving of various areas of the chin, body and head easily and without pain, especially when removing long hair.

The invention also aims to provide prevention and protection from diseases, especially as it is used for one-time only where the blades are not replaced or touched and therefore do not transmit the infection to the consumer himself.

The invention further aims to increase the effectiveness and success of the shaving process through the use of a razor comb mounted on the device of the invention which contributes to combing the chin hair, moustache and sideburns during shaving and trimming.

In accordance with one embodiment, a disposable razor device includes a handle with a distal end, a proximal end, and a body extending therebetween, a fixed head integral with the handle, at least one fixed razor blade attached to a bottom edge of the fixed head, and a removable head including a protection strip and at least one razor blade inserted therein. The removable head is configured to be attached to and removed from the fixed head of the razor device.

A push button release mechanism may be positioned on the handle. The actuation of the push button allows the removable head to be detached from the fixed head of the razor device. The removable head may include two razor blades inserted therein. The protection strip may be positioned above the two razor blades in the removable head. The two razor blades of the removable head may be positioned above the fixed razor blade of the fixed head. The razor device may be made of plastic. The handle may include a cavity extending from the distal end to the proximal end of the handle. The handle may be cylindrical and tapered at the distal end.

In accordance with another embodiment, a method of manufacturing a disposable razor device as described hereinabove includes the steps of creating a mold for the disposable razor device, injecting plastic into the mold, and inserting the fixed razor blade on the bottom edge of the fixed head and the at least one razor blade in the removable head before the plastic has set. The razor blades protrude from the razor device after being inserted. The method may include a step of attaching the removable head to the fixed head of the razor device. The method may include a step of inserting a push button release mechanism through a top surface of the handle, thereby configuring the push button to protrude from the top surface. The protection strip may be positioned above the at least one razor blade in the removable head.

These and other features and characteristics of the razor device, as well as the methods of manufacture and functions of the related elements of the razor device, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a razor device in accordance with this disclosure, wherein a removable razor head is shown removed from a razor body;

FIG. 2 is a side view of the razor device of FIG. 1;

FIG. 3 is front-side view of the razor device of FIG. 1;

FIG. 4 is a back-view of the razor device of FIG. 1;

FIG. 5 is a another perspective view of the razor device of FIG. 1;

FIG. 6 is front view of the razor device of FIG. 1;

FIG. 7 is a top view of the razor device of FIG. 1;

FIG. 8 is another perspective view of the razor device of FIG. 1;

FIG. 9 is a side view of the razor device of FIG. 1, wherein the removable razor head has been coupled with the razor body;

FIG. 10 is a perspective view of the razor device of FIG. 9;

FIG. 11 is a bottom view of the razor device of FIG. 9;

FIG. 12 is a top view of the razor device of FIG. 9;

FIG. 13 is another top view of the razor device of FIG. 9;

FIG. 14 is a side view of the razor device of FIG. 9;

FIG. 15 is another side view of the razor device of FIG. 9;

FIG. 16 is a another top view of the razor device of FIG. 9; and

FIGS. 17-19 are perspective views of the razor device of FIG. 1.

### DESCRIPTION OF THE INVENTION

For purposes of the description hereinafter, spatial orientation terms, as used, shall relate to the referenced embodiment as it is oriented in the accompanying figures, drawings, or otherwise described in the following detailed description. However, it is to be understood that the embodiments described hereinafter may assume many alternative variations and configurations. It is also to be understood that the specific components, devices, features, and operational sequences illustrated in the accompanying drawings, figures, or otherwise described herein are simply exemplary and should not be considered as limiting.

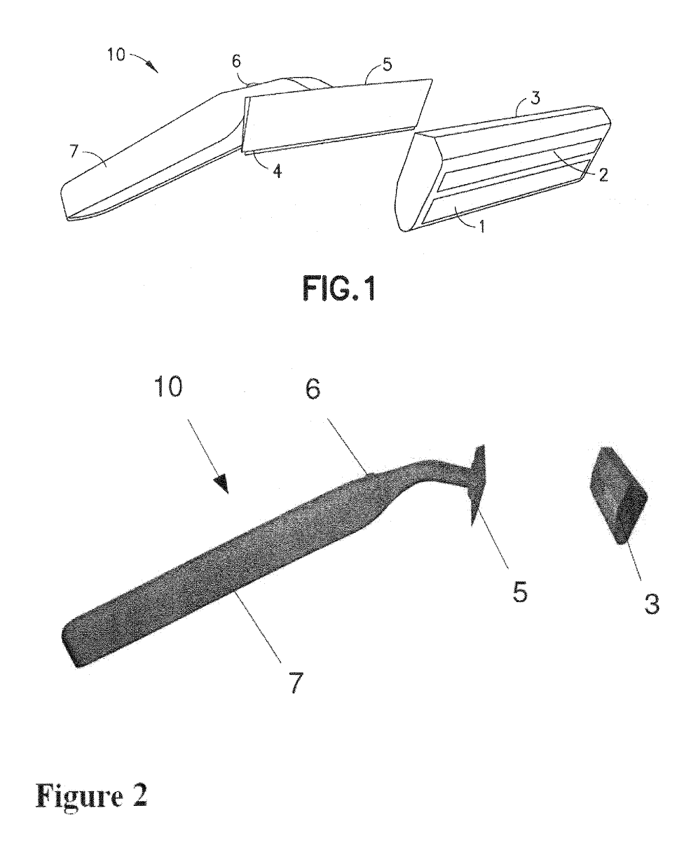

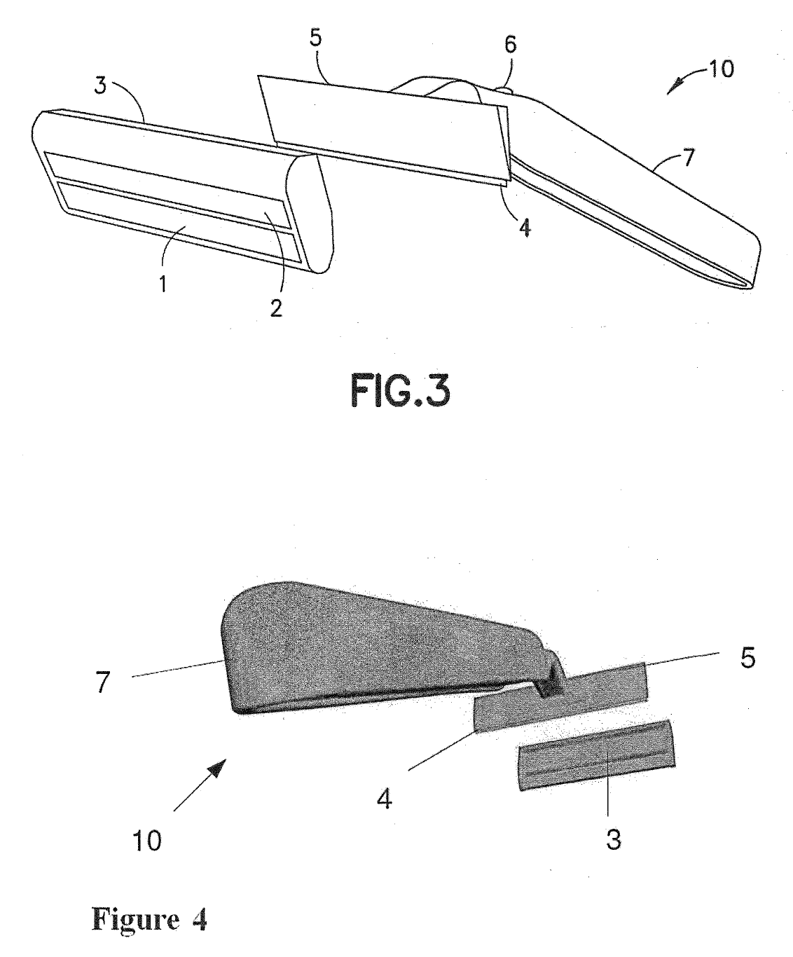

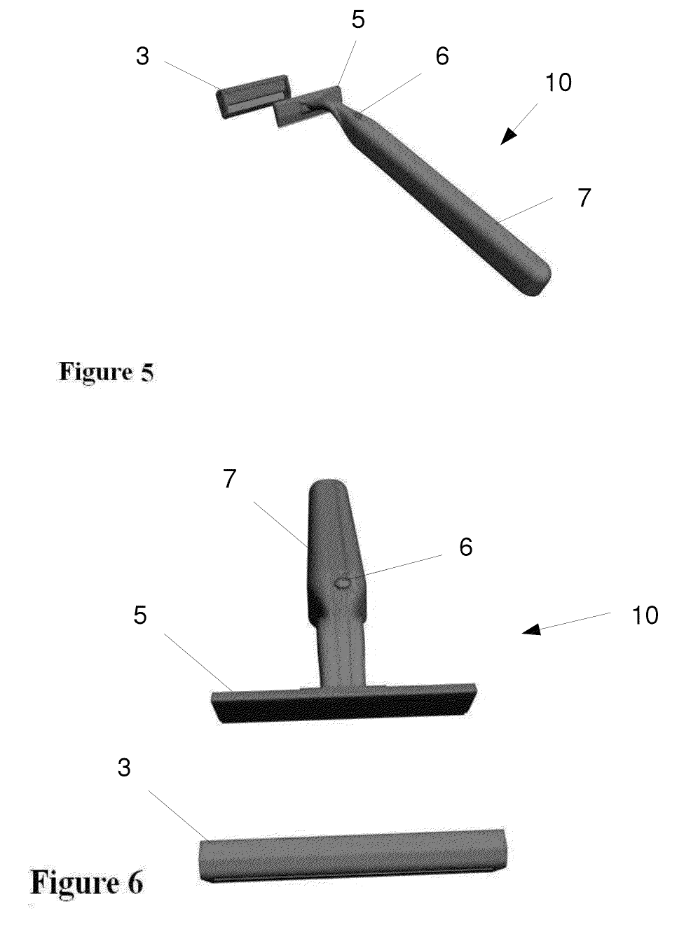

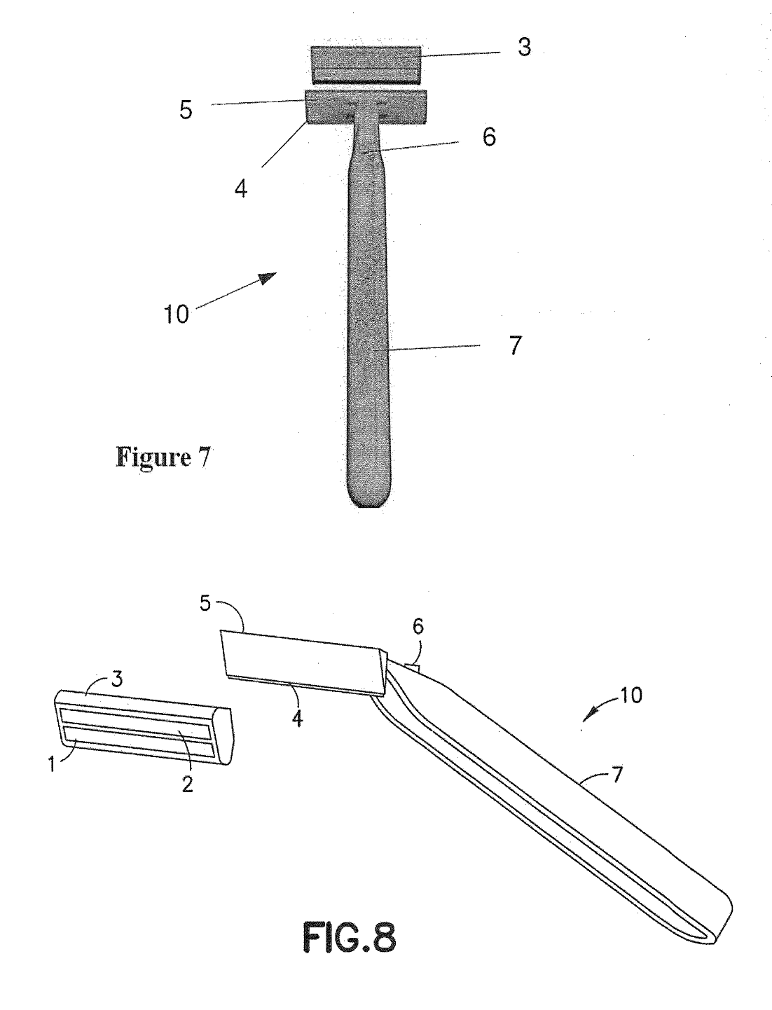

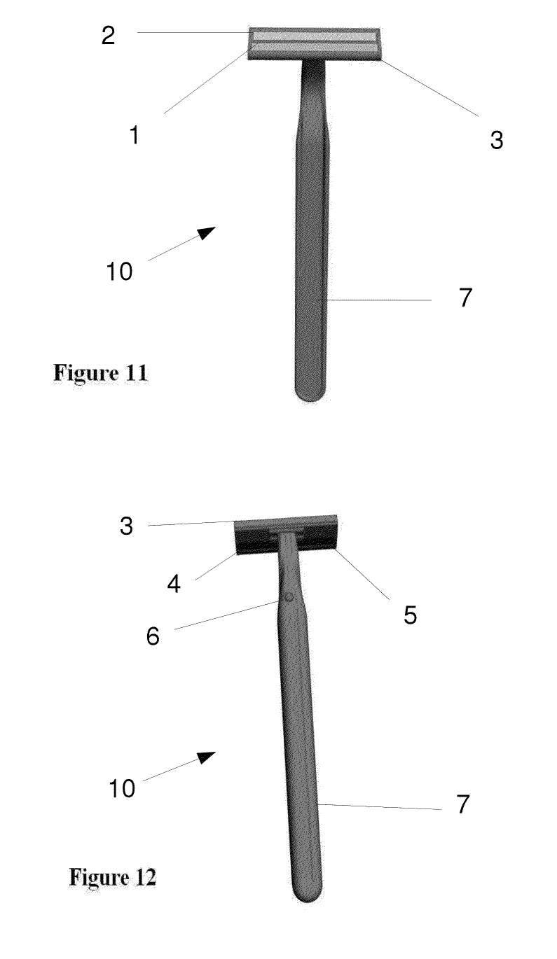

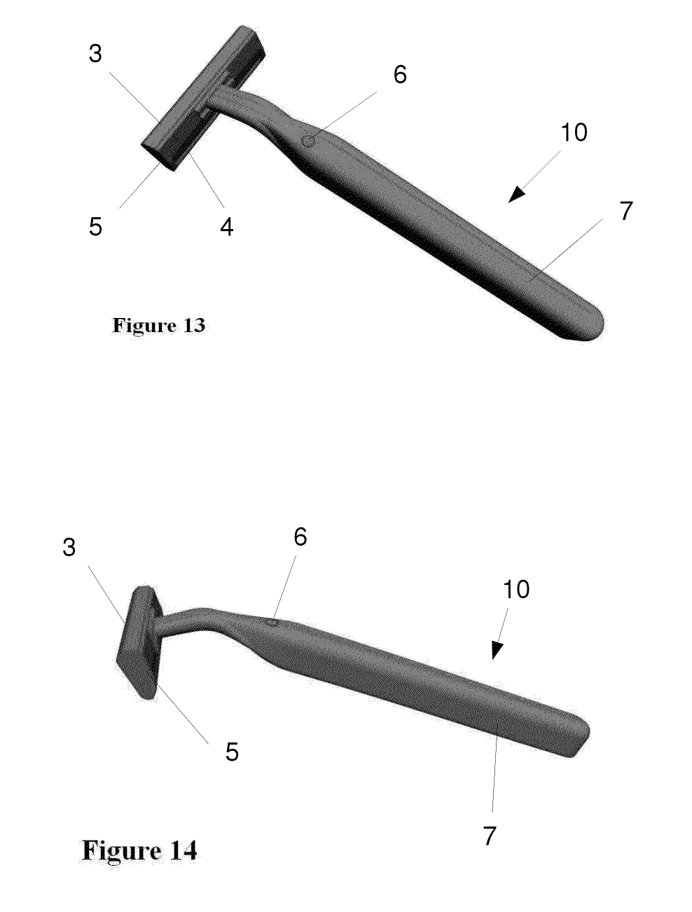

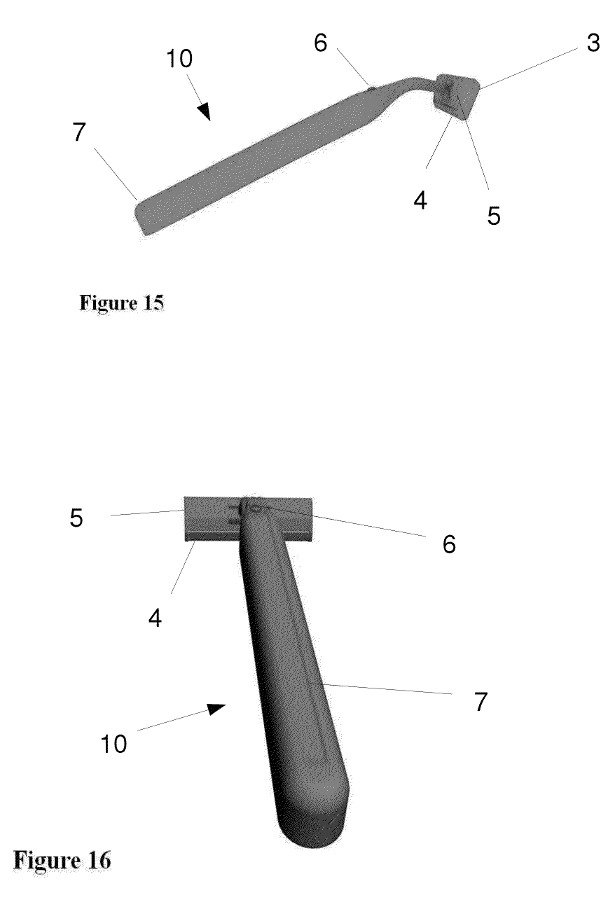

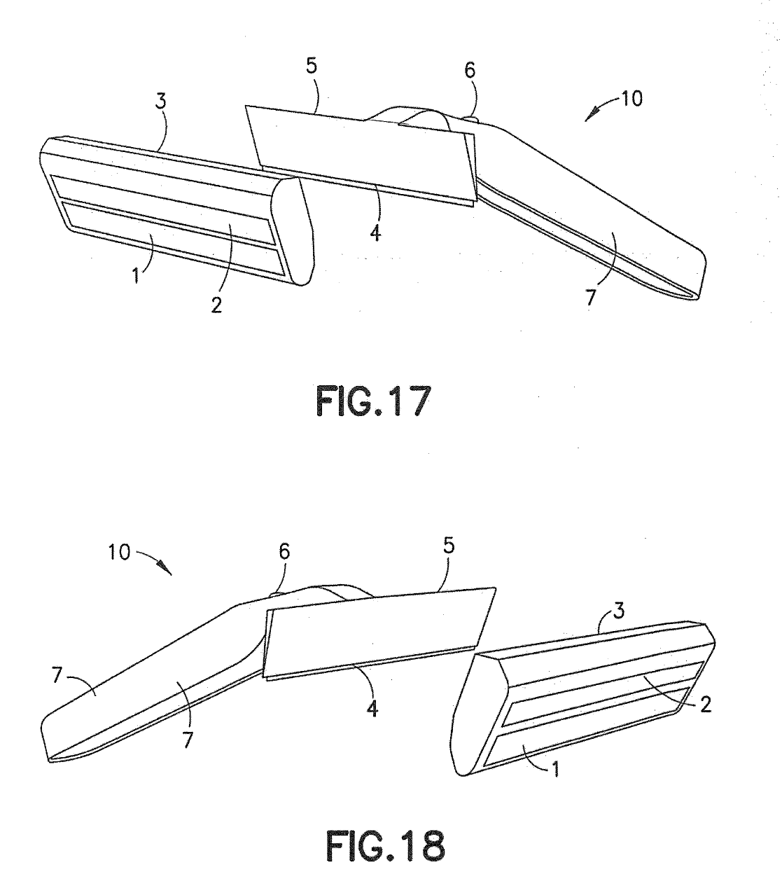

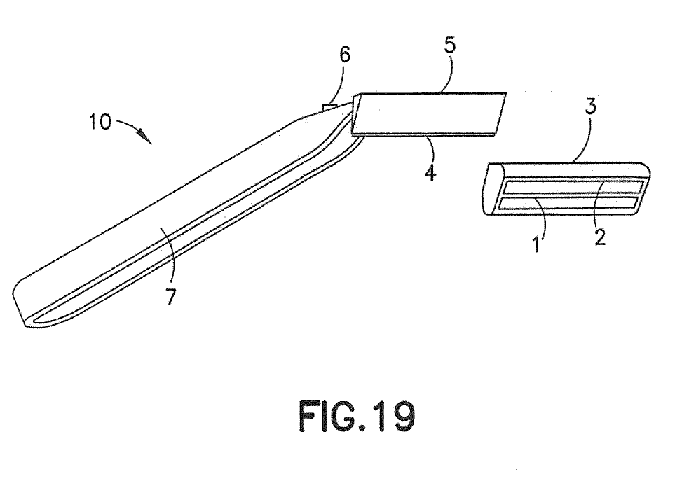

The present invention is directed to, in general, a razor device and, in particular, to a razor device with a removable razor head and an integral razor fixed to a razor body. Certain preferred and non-limiting embodiments of the components of the razor device are illustrated in FIGS. 1-19.

With reference to FIGS. 1-9, a razor device 10 is shown in one embodiment of the disclosure. A handle 7 includes a distal end, a proximal end, and a body extending therebetween. In one embodiment of the invention, the handle 7 is rectangular in shape, with curved, beveled edges. Additional shapes and sizes are also contemplated for the handle 7, such as a cylindrical or flat shape. The handle 7 may include a solid body or a hollow cavity therein. The handle 7 may be manufactured from various materials including, but not limited to, plastic, stainless steel, aluminum, or wood. At a distal end of the handle 7, the body may taper, thereby decreasing the height of the handle 7.

Fixed to the distal end of the handle 7 is a fixed head 5 with a front face support surface. In one embodiment, the fixed head 5 is generally rectangular in shape. The fixed head 5 includes a top edge, a bottom edge, and two side edges. The front face support surface is substantially smooth. At least one fixed razor blade 4 is fixed in the bottom edge of the fixed head 5. The fixed razor blade 4 is rectangular in shape, includes a cutting edge, and has substantially the same width as the fixed head 5 of the razor device 10. Long hair can be shaved from an individual's skin by using this fixed razor blade 4. Additionally, the fixed razor blade 4 can be used to trim the tips, such as defining the chin, mustache, and sideburns.

The razor device 10 also includes a removable head 3 including at least one razor blade 1 and a protection strip 2. The removable head 3 can also be rectangular in shape, including a top edge, a bottom edge, and two side edges. A contact surface is included on a back face of the removable head 3. The at least one razor blade 1 and the protection strip 2 are also substantially rectangular and extend from one side edge of the removable head 3 to an opposing side edge. In one embodiment, the at least one razor blade 1 is positioned beneath the protection strip 2 on the removable head 3. Two razor blades 1 may be used with the razor device 10, thereby providing a larger shaving/cutting surface. These razor blades 1 are used for shaving short hair and providing a smooth surface on an individual's skin. The at least one razor blade 1 includes a bottom, cutting edge used for, among other uses, shaving or cutting an individual's facial hair. The protection strip 2 is used to provide a smooth transitional surface that allows an individual to comfortably apply the razor device 10 to his/her skin. The protection strip 2 also reduces skin irritation and accidental cutting of an individual's skin.

In use, the removable head 3 can be attached to and removed from the fixed head 5 of the handle 7. An individual can attach the removable head 3 by pressing the contact surface of the removable head 3 to the support surface of the fixed head 5. As the removable head 3 is pressed onto the fixed head 5, the edges of the fixed head 5 snap into place in a cavity of the removable head 3. The cavity of the removable head 5 is positioned behind the at least one razor blade 1 and the protection strip 2. According to one embodiment, the fixed head 5 and the fixed razor blade 4 are hidden behind the removable head 3 when the removable head 3 is attached to the fixed head 5. Once an individual has used the razor device 10, the removable head 3 can be replaced with a new removable head 3. By replacing the removable head 3, sharper and cleaner razors can be provided in a new removable head. This helps to reduce the potential for diseases and germs to spread with the used razor blades 1 of the removable head 3. The razor device 10 also includes a push button release mechanism 6 that assists in removing and replacing the removable head 3. The push button 6 may be of any type known to one of ordinary skill in the art. The push button 6 is positioned on a top surface of the handle 7. By actuating the push button 6, the removable head 3 is detached from the fixed head 5.

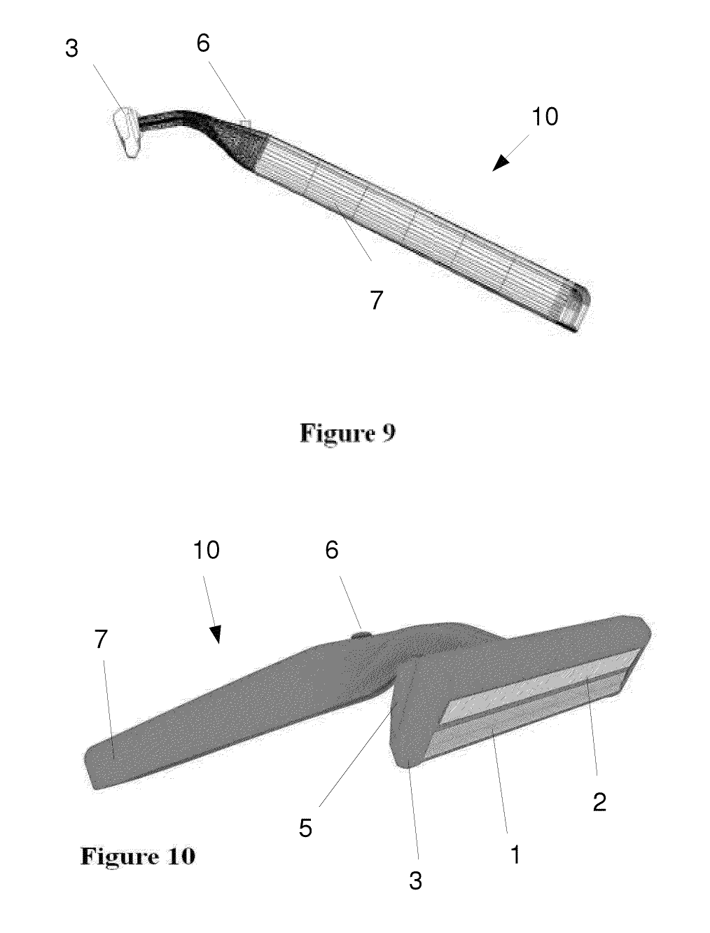

In reference to FIGS. 9-16, once the removable head 3 is attached to the fixed head 5 of the handle 7, a single razor device 10 is assembled. In use, an individual can use the fixed razor blade 4 to shave longer hair and use the razor blades 1 of the removable head 3 to shave shorter hair.

A method of manufacturing a razor device 10 is also contemplated in this disclosure. A first step of this method includes forming a mold configured in the shape of the above-described razor device 10. The mold is then injected with plastic to produce the desired razor device 10. The razor blades 1, 4 of each head 3, 5 are then mounted in a protruding manner, becoming an integral part of each respective head 3, 5. These razor blades 1, 4, once set, cannot be removed or replaced. The push button 6 is made of plastic, and is inserted through a hole in the top surface of the handle 7. The push button 6 thereby protrudes from the top surface of the handle 7, opposite the surface from where the fixed razor 4 is positioned. The removable head 3 is then mounted on a front surface of the fixed head 5 of the razor device 10. A protection strip 2 is also mounted in the removable head 3, and is positioned above the razor blades 1 of the removable head 3.

While various embodiments of the razor device were provided in the foregoing description, those skilled in the art may make modifications and alterations to these embodiments without departing from the scope and spirit of the invention. For example, it is to be understood that this disclosure contemplates that, to the extent possible, one or more features of any embodiment can be combined with one or more features of any other embodiment. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A disposable razor device, comprising:
a handle including a distal end, a proximal end, and a body extending therebetween,
a fixed head integral with the handle,
at least one fixed razor blade attached to a bottom edge of the fixed head, and
a removable head including a protection strip and at least one razor blade inserted therein;
wherein the removable head is configured to be attached to and removed from the fixed head of the razor device.

2. The disposable razor device as claimed in claim 1, further comprising a push button release mechanism positioned on the handle, wherein the actuation of the push button allows the removable head to be detached from the fixed head of the razor device.

3. The disposable razor device as claimed in claim 2, wherein the removable head includes two razor blades inserted therein.

4. The disposable razor device as claimed in claim 3, wherein the protection strip is positioned above the two razor blades in the removable head.

5. The disposable razor device as claimed in claim 4, wherein the two razor blades of the removable head are positioned above the fixed razor blade of the fixed head.

6. The disposable razor device as claimed in claim 5, wherein the razor device is made of plastic.

7. The disposable razor device as claimed in claim 6, wherein the handle includes a cavity extending from the distal end to the proximal end of the handle.

8. The disposable razor device as claimed in claim 7, wherein the handle is cylindrical and tapers at the distal end.

9. A method of manufacturing a disposable razor device, comprising the steps of:
(a) creating a mold for a disposable razor device, comprising:
a handle including a distal end, a proximal end, and a body extending therebetween,
a fixed head integral with the handle,
at least one fixed razor blade attached to a bottom edge of the fixed head, and
a removable head including a protection strip and at least one razor blade inserted therein;
(b) injecting plastic into said mold; and
(c) inserting the fixed razor blade on the bottom edge of the fixed head and the at least one razor blade in the removable head before the plastic has set, wherein the razor blades protrude from the razor device.

10. The method of manufacturing a disposable razor device as claimed in claim 9, further comprising the step of attaching the removable head to the fixed head of the razor device.

11. The method of manufacturing a disposable razor device as claimed in claim 10, further comprising the step of inserting a push button release mechanism through a top surface of the handle, thereby configuring the push button to protrude from the top surface.

12. The method of manufacturing a disposable razor device as claimed in claim 11, wherein the protection strip is positioned above the at least one razor blade in the removable head.
